(19) United States
(12) Patent Application Publication
(10) Pub. No.: US 2020/0143007 A1
(43) Pub. Date: May 7, 2020

(54) METHOD OF INTEGRATING TOPOLOGY OPTIMIZATION FOR MAKING A COMPLEMENTARY BONE MODEL

(71) Applicants: Chun-Li Lin, New Taipei City (TW); Cheng-Hsien Wu, Taipei City (TW); Yu-Tzu Wang, Taipei City (TW); Chia-Hsuan Li, Taipei City (TW)

(72) Inventors: Chun-Li Lin, New Taipei City (TW); Cheng-Hsien Wu, Taipei City (TW); Yu-Tzu Wang, Taipei City (TW); Chia-Hsuan Li, Taipei City (TW)

(73) Assignee: National Yang-Ming University, Taipei City (TW)

(21) Appl. No.: 16/671,235

(22) Filed: Nov. 1, 2019

(30) Foreign Application Priority Data
Nov. 6, 2018 (TW) 107139257

(51) Int. Cl. G06F 17/50

(52) U.S. Cl. CPC G06F 17/5018; G06F 2217/12; G06F 2217/16

(57) ABSTRACT

A method of making a complementary bone model includes performing standard topology optimization on a complementary bone model for a defected bone under different mechanics conditions; performing both a finite element analysis and a weighted topology optimization by performing topology optimization in terms of ratio coefficients under the different mechanics conditions; integrating the results of standard topology optimization to obtain a weighted topology optimization structure for making a complementary bone model which is three-dimensional; and using additive manufacturing technology to manufacture the complementary bone model, thereby finishing a complementary bone.

### BACKGROUND OF THE INVENTION

### 1. Field of the Invention

The invention relates to topology optimization and more particularly to a method of integrating standard topology optimization for making a complementary bone model having characteristics of being lightweight and supported from a plurality of different loading conditions.

### 2. Description of Related Art

Topology optimization is related to the technique of structure optimization and can be used to create an optimization structural model complying with prescribed boundary condition and load condition. But standard topology optimization is an optimization technique obtained by analysis under a single condition (e.g., load at a single direction). However, it is clinically possible that there are differences in directions, strength, and locations of force. Thus, standard topology optimization appropriate for a single condition is not applicable to the above condition.

A mandible can be fractured after being injured or removing tumor out of the bone. Thus, the defected mandible is required to mend to return to its normal appearance and jawing function by surgery. Referring to FIG. 14, it shows a metal complementary bone for mandible. However, jawing function, weight and structure of the metal complementary bone for mandible are required to improve. Firstly, the metal complementary bone for mandible does not allow dental implant so the jawing function of mastication of a patient is not fully mended. Further, even after the jawing function of mastication of a patient has been fully mended, the heavy complementary bone for mandible can cause the complementary bone to collapse or break, or the adjacent bones may be fractured by burdened with the great weight of the metal complementary bone for mandible. As a result, the surgery fails. Furthermore, standard topology optimization is used for analysis under a single mechanics condition and it is not applicable for the jawing function involved many mechanics conditions. Therefore, it does not apply to clinical treatment.

Thus, the need for improvement still exists.

### SUMMARY OF THE INVENTION

It is therefore one object of the invention to provide a method of making a complementary bone model, comprising performing standard topology optimization on a complementary bone model for a defected bone under different mechanics conditions; optimal structure obtained by performing both a finite element analysis and a weighted topology optimization by performing standard topology optimization in terms of ratio coefficients under the different mechanics conditions wherein the weighted calculation is performed in the following equations:

$$D = {\sum }_{i = 1}^{N} {c}_{i} {d}_{i} = {c}_{1} {d}_{1} + {c}_{2} {d}_{2} + … + {c}_{N} {d}_{N} , {d}_{i} = [ {ρ}_{1} , {ρ}_{2} , {ρ}_{3} , … , {ρ}_{e} ]$$

where D is a weighted topology optimization structure, cᵢ is ratio coefficient under one of the different mechanics conditions, dᵢ is standard topology optimization structure under a single mechanics condition, N is the number of the different mechanics conditions, and ρₑ is pseudo density per element; integrating the results of standard topology optimization to obtain a weighted topology optimization structure for making an optimal complementary bone model which is three-dimensional; and using additive manufacturing technology to manufacture the optimal complementary bone model, thereby finishing a complementary bone.

The invention has the following advantages and benefits in comparison with the conventional art: the complementary bone obtained by performing both weighted topology optimization and finite element analysis has an increased mechanical performance because weighted topology optimization is integrated under different mechanics conditions for meeting requirements of clinical diagnosis. The complementary bone is lightweight and supported from a plurality of different loading conditions. Mechanical performance is improved. It is particularly appropriate for healing patients by an optimal structure with internal supporting posts. It can restore bone defect portions of a bone to its normal appearance and functions. Finally, it avoids implant failure.

The above and other objects, features and advantages of the invention will become apparent from the following detailed description taken with the accompanying drawings.

### BRIEF DESCRIPTION OF THE DRAWINGS

FIG. 1 is a flow chart of a method of integrating topology optimization according to the invention;

FIG. 2 is a flow chart of a method of integrating topology optimization for making a complementary bone model according to the invention;

FIG. 3 shows a mandible and a mandible body (bone defect portion) model created by computed tomography (CT);

FIG. 4 shows bone defect portions of a mandible model;

FIG. 5 is a perspective view of a complementary bone model of the invention;

FIG. 6 is a top plan view of the complementary bone model;

FIG. 7 schematically shows a finite element analysis performed on the complementary bone model;

FIG. 8 schematically shows standard topology optimization performed on the complementary bone model;

FIG. 9 schematically shows integrating topology optimization performed on an internal structure of the complementary bone model;

FIG. 10 is a front perspective view of the complementary bone model of mandible of the invention;

FIG. 11 is a left side view of FIG. 10;

FIG. 12 is a right side view of FIG. 10;

FIG. 13 is a perspective view of a complementary bone for radius; and

FIG. 14 shows a metal complementary bone for mandible according to the conventional art.

### DETAILED DESCRIPTION OF THE INVENTION

A method of integrating topology optimization for making a complementary bone model in accordance with the invention aims to perform standard topology optimization on a complementary bone model for a defected bone (e.g., mandible) under different mechanics conditions, and optimal structure obtained by performing a finite element analysis and a weighted topology optimization by carrying out standard topology optimization in terms of ratio coefficients under the different mechanics conditions in which the weighted calculation is performed in the following equations:

$$D = {\sum }_{i = 1}^{N} {c}_{i} {d}_{i} = {c}_{1} {d}_{1} + {c}_{2} {d}_{2} + … + {c}_{N} {d}_{N} , {d}_{i} = [ {ρ}_{1} , {ρ}_{2} , {ρ}_{3} , … , {ρ}_{e} ]$$

where D is a weighted topology optimization structure, cᵢ is ratio coefficient under one of the different mechanics conditions, dᵢ is topology optimization structure under a single mechanics condition, N is the number of the different mechanics conditions, and ρₑ is pseudo density per element. The different mechanics conditions mean analysis under axial force and oblique force respectively.

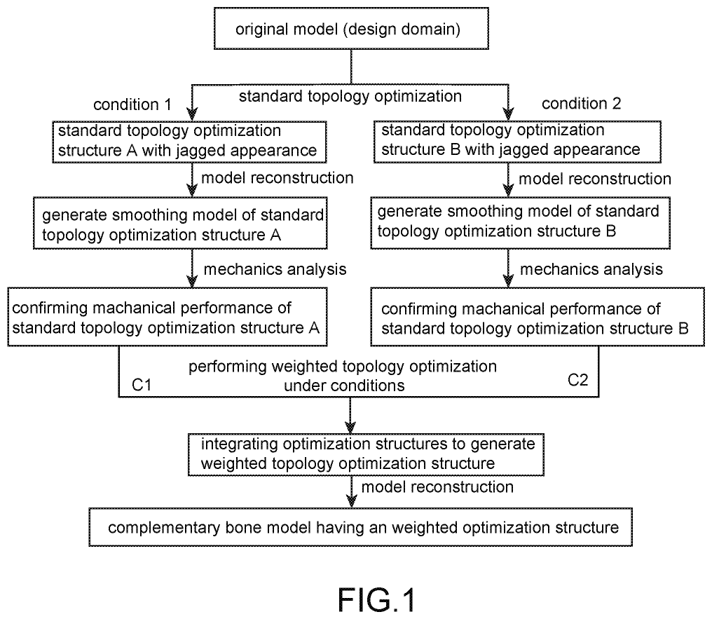

The method of integrating topology optimization according to the invention is based on definition of topology density and the weighted topology optimization and is illustrated in a flow chart of FIG. 1. As illustrated, an analysis is performed on definition of an original model. After standard topology optimization has been performed under two different mechanics conditions respectively, two results of optimization, i.e., standard topology optimization structure A with jagged appearance and standard topology optimization structure B with jagged appearance, are obtained. Smoothing model of standard topology optimization structural model A and smoothing model of standard topology optimization structural model B are obtained by reconstructing the standard topology optimization structures A and B with jagged appearance respectively. Next, a finite element analysis is performed to confirm a mechanical performance of the smoothing model of standard topology optimization structure model A and B respectively based on two mechanics conditions. Next, a weighted topology optimization step is performed under each condition in which each smoothing model of standard topology optimization structure is multiplied by ratio coefficient c₁ or c₂ to obtain an integrated optimization structure. As a result, a complementary bone model having a weighted optimization structure is reconstructed.

Topology optimization, a finite element analysis and an optimization algorithm are integrates so that an optimization topology density value ρₑ (i.e., pseudo density per element) is distributed to each element of a design domain. As an end, a topology optimization structure is obtained in which 0≤ρₑ≤1. For ρₑ (i.e., pseudo density per element) being 0, it means that material is removed. For ρₑ being 1, it means that the material is reserved. For ρₑ being a value greater than 0 but less than 1, it means that the removal or the reservation of the material is determined by executing computer aided engineering analysis software. Topology optimization objective function is expressed in the following equations:

$$\{ \begin{matrix}min V = F ( {ρ}_{e} ) \\ s . t {σ}_{e} \leq \overline{σ}\end{matrix} , F ( {ρ}_{e} ) = {\sum }_{e = 1}^{n} {ρ}_{e} {v}_{e} , [ {E}_{e} ] = [ E ( {ρ}_{e} ) ] , [ {σ}_{e} ] = [ {E}_{e} ] [ {ɛ}_{e} ]$$

where ρₑ is pseudo density per element, σₑ is equivalent stress per element, σ̅ is allowed maximum equivalent stress of structure, n is the number of the elements, vₑ is volume per element, Eₑ is Young's modulus per element, and εₑ is strain per element.

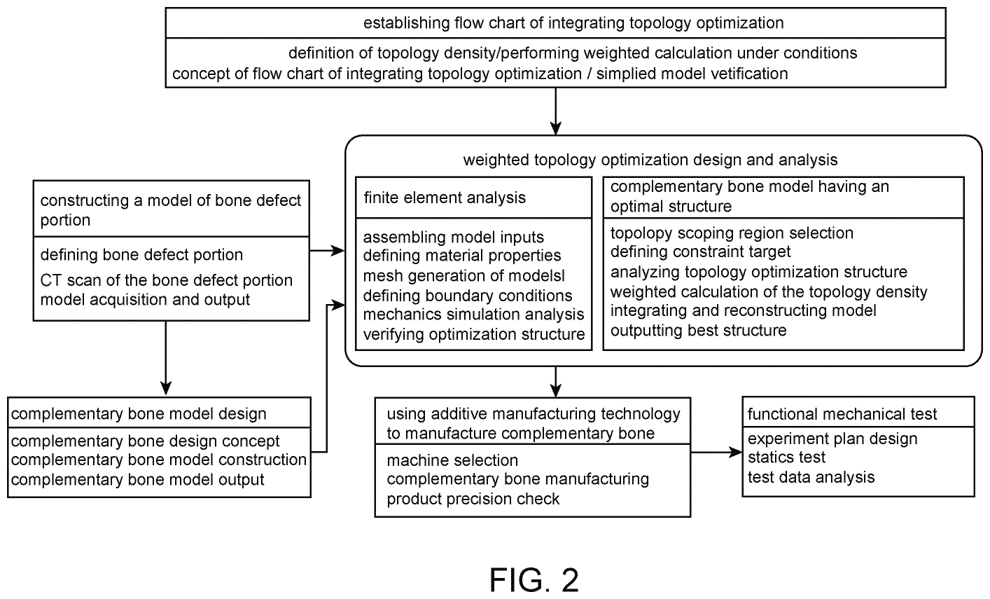

Referring to FIG. 2, a flow chart of a method of integrating topology optimization for making a complementary bone model in accordance with the invention is illustrated. The method comprises the following steps:

(a) identifying a bone defect portion of a bone by means of CT;

(b) making an initial complementary bone model based on the bone defect portion;

(c) performing a weighted calculation on the initial complementary bone model by means of a finite element analysis and standard topology optimization under different mechanics conditions to create weighted topology optimization structure which is in turn used to make a final complementary bone model having an weighted topology optimization structure; and

(d) using additive manufacturing technology to manufacture the final complementary bone model having an weighted topology optimization structure, thereby finishing a complementary bone.

The method of the invention can be applied to mandible as detailed in steps of the following embodiments:

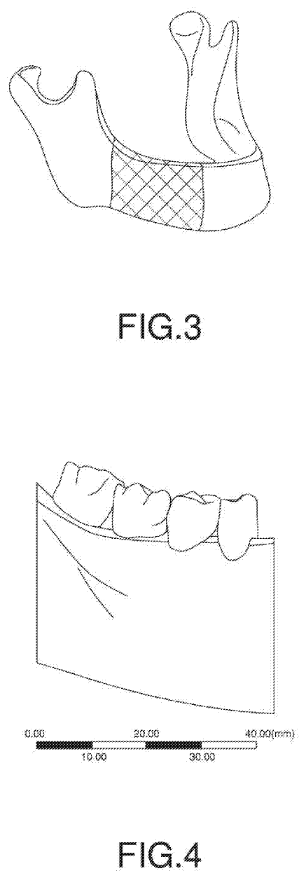

Referring to FIGS. 3 and 4 in conjunction with FIG. 2, a bone defect portion of a mandible is identified by means of CT (see a criss-cross area of FIG. 3). Reverse engineering software is executed to locate a mandible, a mandibular first premolar to a second molar. A three-dimensional model is made by means of image overlapping and outputted. The three-dimensional model is smoothed to identify the bone defect portion of the mandible, i.e., a right mandible body model. The four independent intact crowns match the first premolar to the second molar profiles.

Further, the crown positions were aligned to the original axis of the teeth of the right mandible body model. As such, models of the mandibular first premolar to the second molar are reconstructed. Finally, a mandible model incorporating the right mandible body model and a denture is reconstructed by integrating the models.

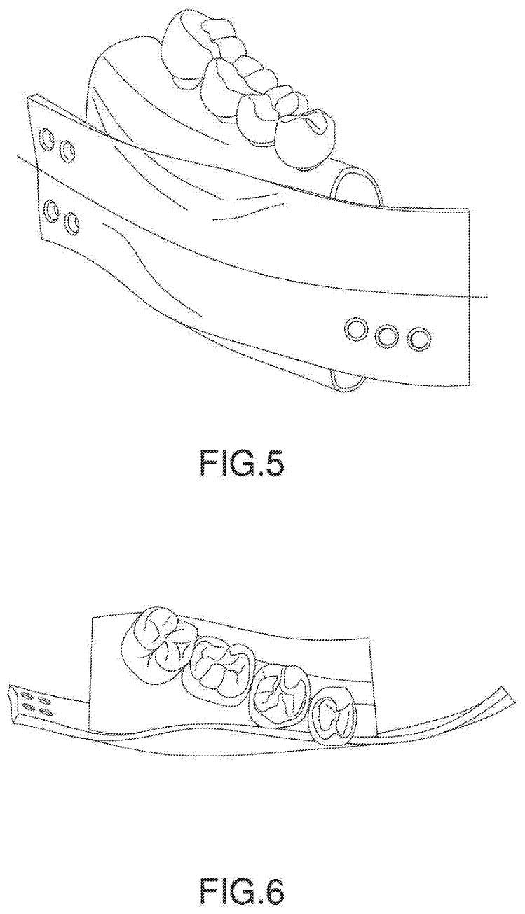

Referring to FIGS. 5 and 6 in conjunction with FIG. 2, while a complementary bone model of mandible is constructed based on the mandible model, restoration of a normal mastication function, restoration of an aesthetic face, and fastening at two sides of a mandible are considered. The jawing function of the bone defect portion of a mandible is restored by referring to dental implants and crowns of teeth in a dental implants operation with a unitary piece being manufactured. Portions of a complementary bone model are obtained from the mandible model so that it can be complementarily secured to an outer surface of a dissected mandible, thereby restoring an aesthetic face. For securing the produced complementary bones to two sides of the mandible by screws, extending wing-like members are formed on either side of the complementary bone model in the embodiment. As an end, the complementary bone model is made.

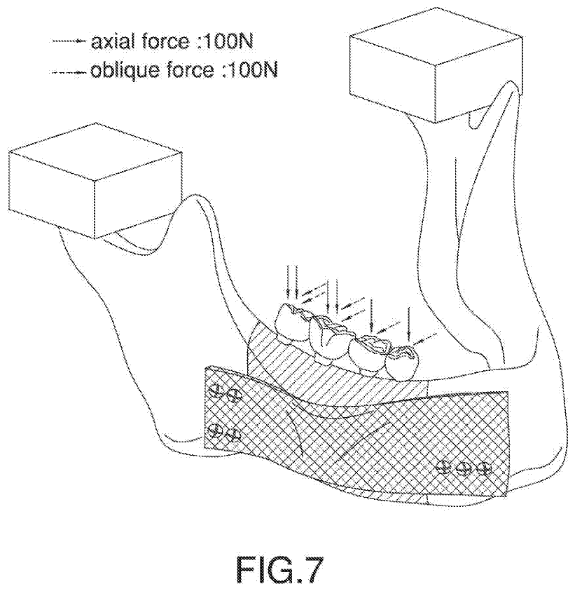

Referring to FIG. 7 in conjunction with FIG. 2, prior to performing the topology optimization, a finite element analysis on mechanics is executed. The mandible model, the complementary bone model, and screw models structured in the steps (a) and (b) are sent to analysis software for integration. Also, a joint cavity model is drawn and fixed. Material definition is next done. The mandible model includes cortical bone and cancellous bone in which the joint cavity model is related to cortical bone.

The complementary bone model is made of Ti-6Al-4V. The screw models are made of Ti-6Al-7Nb. Contact between the models are bonded. Elements are selected as a linear tetrahedron structure in the analysis software. Free mesh are used to generate mesh of the models.

In the embodiment, an axial force and an oblique force of 200N are used in a molar zone and an axial force and an oblique force of 100N are used in a premolar zone of the complementary bone model respectively for topology optimization in which in a first stage, a wing-like structure is built at either side of the complementary bone model and in a second stage, a support structure is built in the complementary bone model.

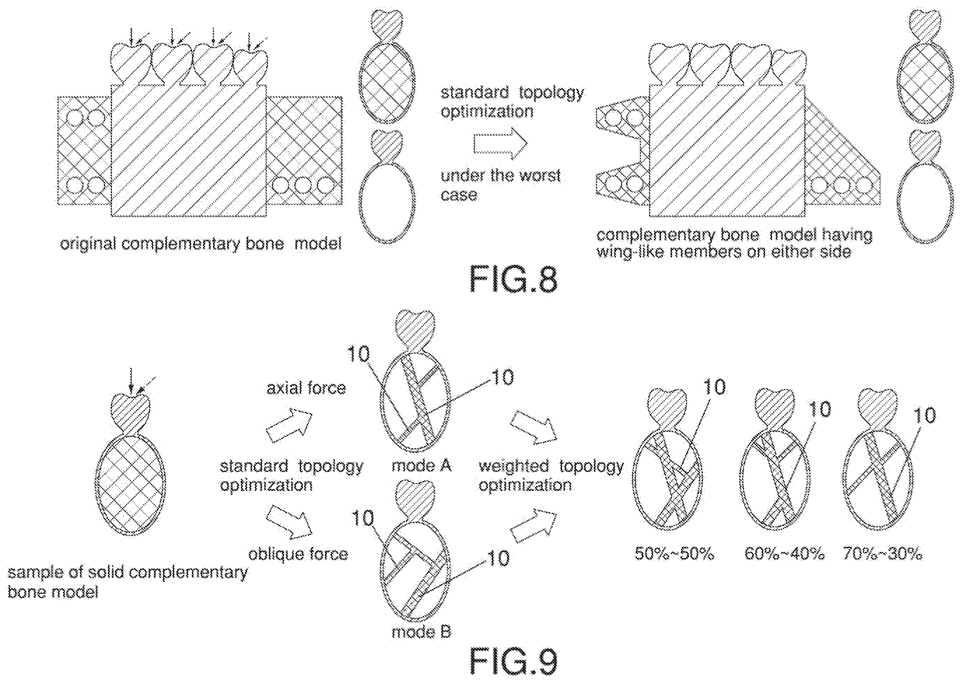

Referring to FIGS. 8 and 9 in conjunction with FIG. 2, an axial force and an oblique force are applied to a solid complementary bone model and a hollow complementary bone model respectively. A worst case is found by means of the two forces. Conditions set by the worst situation are used to for standard topology optimization of the bone structure in the first stage as shown in FIG. 8. Next, the obtained optimized wing-like structural model cooperates with the solid complementary bone model prior to entering the above standard topology optimization for internal structure, thereby finding an optimization structure under each of the conditions. Next, a weighted calculation is done with different percentages of applied axial force 30-80% and oblique force 20-70% (e.g., axial force of 50% and oblique force of 50%, axial force of 60% and oblique force of 40%, or axial force of 70% and oblique force of 30%) based on results and clinical jawing behavior as shown in FIG. 9. Further, model reconstruction and mechanics analysis steps are performed to determine which complementary bone model has a better mechanical performance. Finally, the complementary bone model having a weighted topology optimization structure is made.

The above complementary bone model having a weighted topology optimization structure is made by means of additive manufacturing with Ti-6Al-4V as material. As a result, a complementary bone for mandible body is finished. Based on the above weighted calculation involved axial force and oblique force.

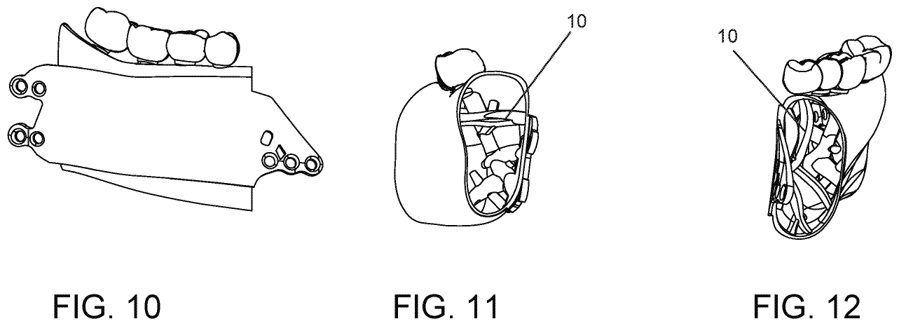

Referring to FIGS. 10, 11, and 12, the complementary bone is hollow with a plurality of internal supports and a plurality of dentures on a top. The internal supports 10 are supporting posts, supporting plates or supporting blocks. Forces applied to different portions of a tooth are different due to different bone defect portions of the mandible. For producing a complementary bone having the weighted topology optimization structure adjacent to the incisors, horizontal force, in addition to the axial force and the oblique force, is used for the weighted calculation in which the axial force 30-80%, the oblique force 20-70%, and the horizontal force 10-50% are applied.

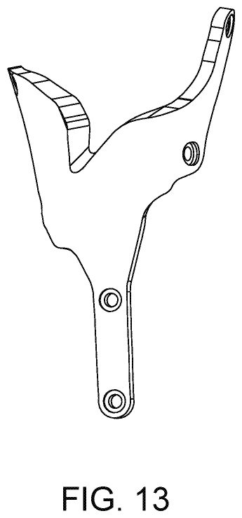

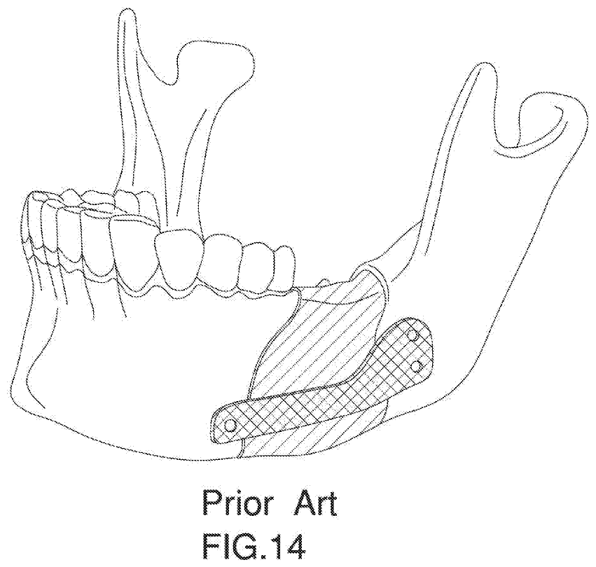

Referring to FIG. 13, the invention further provides a bone plate (i.e., complementary bone) for radius. Typically, back of a distal end of the radius is fastened by two bone plates and this is disadvantageous due to requirements of two incision positions, long surgery time and expensive fee. Advantageously, the invention integrates the two bone plates as a single one, uses a method of integrating topology optimization to devise the bone plate on the back of the distal end of the radius, and divides load applied to the distal end of the radius into axial force, bending stress and twisting torque in which the twisting torque is the strongest force applied to the distal end of the radius. It is envisaged by the method of integrating topology optimization that a weighted calculation is done with different percentages of applied axial force 30-80%, bending stress 10-25%, and twisting force 20-40%. As a result, a bone plate having a best mechanical performance is obtained. In detail, a top of the complementary bone plate is bent and a bottom thereof is formed with an extending support member after doing a weighted calculation based on the applied axial force, bending stress, and twisting torque.

While the invention has been described in terms of preferred embodiments, those skilled in the art will recognize that the invention can be practiced with modifications within the spirit and scope of the appended claims.

What is claimed is:

1. A method of making a complementary bone model, comprising:
(a) performing standard topology optimization on a complementary bone model for a broken bone under different mechanics conditions;
(b) performing both a finite element analysis and a weighted topology optimization by performing standard topology optimization in terms of ratio coefficients under the different mechanics conditions wherein the weighted calculation is performed in the following equations:
$$D = {\sum }_{i = 1}^{N} {c}_{i} {d}_{i} = {c}_{1} {d}_{1} + {c}_{2} {d}_{2} + … + {c}_{N} {d}_{N} , {d}_{i} = [ {ρ}_{1} , {ρ}_{2} , {ρ}_{3} , … , {ρ}_{e} ]$$
where D is a weighted topology optimization structure, cᵢ is ratio coefficient under one of the different mechanics conditions, dᵢ is topology optimization structure under a single mechanics condition, N is the number of the different mechanics conditions, and ρₑ is pseudo density per element;
(c) integrating the results of standard topology optimization to obtain a weighted topology optimization structure for making a complementary bone model which is three-dimensional; and
(d) using additive manufacturing technology to manufacture the complementary bone model, thereby finishing a complementary bone.

2. The method of claim 1, wherein the different mechanics conditions are based on a weighted calculation of both an axial force and an oblique force; wherein the axial force is 30-80% and the oblique force is 20-70%; wherein the complementary bone is hollow with a plurality of internal supports and a plurality of dentures on a top; and wherein the internal supports are supporting posts, supporting plates or supporting blocks.

3. The method of claim 1, wherein the different mechanics conditions are based on a weighted calculation of an axial force, an oblique force, and a horizontal force; wherein the axial force is 30-80%, the oblique force is 20-70%, and the horizontal force is 10-50%; wherein the complementary bone is hollow with a plurality of internal supports and a plurality of dentures on a top; and wherein the internal supports are supporting posts, supporting plates or supporting blocks.

4. The method of claim 1, wherein the different mechanics conditions are based on a weighted calculation of an axial force, a bending stress, and a twisting torque; wherein the axial force is 45-65%, the bending stress is 10-25%, and the twisting torque is 20-40%; and wherein a top of the complementary bone is bent and a bottom thereof is formed with an extending support member.
